(19) United States
(12) Patent Application Publication
(10) Pub. No.: US 2011/0062110 A1
(43) Pub. Date: Mar. 17, 2011

(54) Method for Fabricating a Micromirror with Self-Aligned Actuators

(76) Inventors: Karthik Kumar, Austin, TX (US); Xiaojing Zhang, Austin, TX (US)

(21) Appl. No.: 12/881,231

(22) Filed: Sep. 14, 2010

Related U.S. Application Data
(60) Provisional application No. 61/243,012, filed on Sep. 16, 2009.

(51) Int. Cl. B29D 11/00

(52) U.S. Cl. 216/11

(57) ABSTRACT

A method of fabricating a micromirror is disclosed. Initially, a set of coarse features is formed in a low-temperature oxide (LTO) layer deposited on a front side of a wafer. A set of fine features is then formed in a photosensitive material layer deposited on top of the LTO layer, and the fine features are constrained laterally within the coarse features. Next, a portion of the LTO layer is removed to align the width of the coarse features with the width of the fine features. The first silicon dioxide layer and the first and second silicon device layers are subsequently etched to form stator comb fingers and rotor comb fingers. Finally, a rotatable mirror is formed by removing a portion of the substrate on a back side of the wafer, and the silicon dioxide layers from the front and back sides of the wafer.

### PRIORITY CLAIM

The present application claims priority under 35 U.S.C. §119(e)(1) to provisional application No. 61/243,012 filed on Sep. 16, 2009, the contents of which are incorporated herein by reference.

### BACKGROUND OF THE INVENTION

1. Technical Field

The present invention relates to optical scanning devices in general, and in particular to a method for fabricating micromirrors to be utilized in optical scanning devices.

2. Description of Related Art

Conventional electrostatic combdriven micromirrors do not offer perfect linear transformation between input voltages and mechanical scan angles. In addition, conventional electrostatic combdriven micromirrors often experience scanning instabilities due to pull-in phenomena. Thus, self-alignment procedures have been adopted in the micromirror fabrication process in order to mitigate the above-mentioned problems. However, such self-alignment procedures can be overly complicated.

Consequently, it would be desirable to provide an improved method for fabricating combdriven micromirrors.

### SUMMARY OF THE INVENTION

In accordance with a preferred embodiment of the present invention, a set of coarse features is initially formed in a low-temperature oxide (LTO) layer deposited on a front side of a wafer. The wafer includes a substrate, a first and second silicon device layers separated from each other by a first and second silicon dioxide layers. A set of fine features is then formed in a photosensitive material layer deposited on top of the LTO layer, and the fine features are constrained laterally within the coarse features. Next, a portion of the LTO layer is removed to align the width of the coarse features with the width of the fine features. The first silicon dioxide layer and the first and second silicon device layers are subsequently etched to form stator comb fingers and rotor comb fingers. Finally, a rotatable mirror is formed by removing a portion of the substrate on a back side of the wafer, and the silicon dioxide layers from the front and back sides of the wafer.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a diagram of a laser-scanning confocal microscope in which a preferred embodiment of the present invention is applicable;

FIG. 2 is a detailed diagram of a micromirror within the confocal microscope from FIG. 1, in accordance with a preferred embodiment of the present invention;

FIG. 3 shows a set of combdrive actuators within the micromirror from FIG. 2, in accordance with a preferred embodiment of the present invention; and

FIGS. 4a-4i illustrates a method for fabricating the micromirror from FIG. 2, in accordance with a preferred embodiment of the present invention.

### DETAILED DESCRIPTION OF A PREFERRED EMBODIMENT

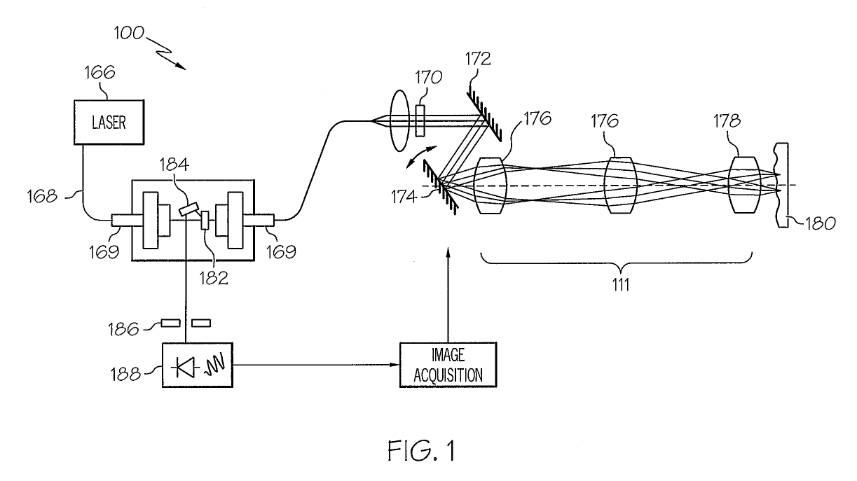

Referring now to the drawings and in particular to FIG. 1, there is depicted a diagram of a laser-scanning confocal microscope in which a preferred embodiment of the present invention is applicable. As shown, a laser-scanning confocal microscope 100 includes a diode laser 166, an avalanche photodetector 188, a stationary mirror 172, a movable micromirror 174 and an objective system 111 having a 3× Keplerian beam expander 176 and a high-numerical aperture aspheric objective lens 178.

A linearly-polarized laser beam from diode laser 166 is initially coupled into a single-mode polarization maintaining (PM) fiber 168. Light exiting PM fiber 168 is then collimated by collimators 169 to a 1 mm diameter beam through a zero-order quarter wave-plate 170 whose axis is oriented at 45° to the incident polarization angle in order to convert the illumination to a circular polarization. After reflection off stationary mirror 172, the illumination is incident on micromirror 174 at 22.5° to micromirror 174 normal. Micromirror 174 scans the illumination across objective system 111, providing an effective numerical aperture of about 0.48 at a tissue sample 180. Reflected light is subsequently converted into a linear polarization that is orthogonal to the initial illumination polarization, which is isolated using a walk-off polarizer 182 and an offset mirror 184, and directed through a spatial filter 186 into avalanche photodetector 188.

Higher values of numerical aperture of objective system 111 can be used to obtain better optical sectioning with high contrast in highly scattering tissue sample 180. The resolution, field of view, and contrast of confocal microscope 100 is largely determined by micromirror 174. There is, however, a trade-off in selecting between resolution and field of view. The product of micromirror 174's size and its optical deflection angle determines the number of resolvable points in the final image, which translates into a given field of view and resolution according to the numerical aperature of objective system 111.

The number of resolvable points, N, for micromirror 174 in a one-dimensional scan is given by

$$N = \frac{D θ}{λ} \qquad ( 1 )$$

where θ is the mechanical scanning half-angle of micromirror 174, λ is the operating wavelength, and D is the diameter of micromirror 174.

Preferably, confocal microscope 100 can be used to provide images of a 200×125 μm field of view at 3.0 frames per second. The number of resolvable points (408×255) in the images is proportional to the product of the diameter of micromirror 174 and the optical scan angle, as stated in Equation (1). Micromirrors with larger diameters (˜1 mm) capable of providing the same deflection angles can be designed within the limits set by the maximum driving voltage and at the cost of increased energy consumption.

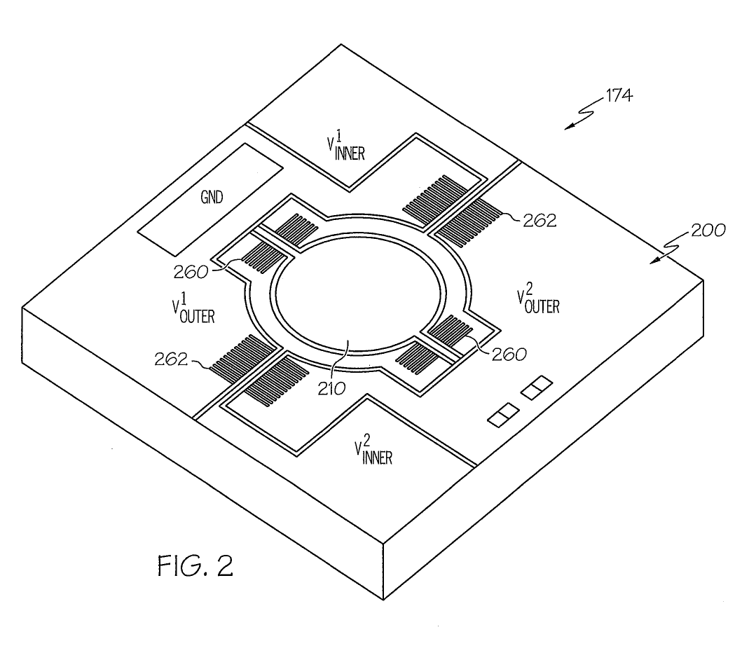

With reference now to FIG. 2, there is depicted a detailed diagram of micromirror 174 from FIG. 1, in accordance with a preferred embodiment of the present invention. The size of a chip 200 containing micromirror 174 is approximately 2.8×2.8 mm², and the diameter of rotatable minor 210 is approximately 1,024 μm. As shown, micromirror 174 has two axes, and electrostatic vertical combdrives can be utilized to provide fast, high-torque rotary actuation about the two axes of micromirror 174. For example, two sets of staggered vertical combdrive actuators 260, 262 can be utilized to rotate rotatable mirror 210 along each of the two axes. The movements of combdrive actuators 260, 262 can be controlled by the application of appropriate electrical biases on chip 200 via pads V¹ᵢₙₙₑᵣ, V¹ₒᵤₜₑᵣ, V²ᵢₙₙₑᵣ, V²ₒᵤₜₑᵣ and Ground. Combdrive actuators 260, 262 include rotor and stator comb fingers. The thickness and spacing between rotor and stator comb fingers are preferably fixed at approximately 8 μm.

The performance of micromirror 174 is characterized by its response to various electrical signal inputs. For example, one input can be a sinusoidal variable-frequency voltage with suitable offset (to ensure the applied voltage was always positive) between ground and one of combdrive actuators 260, 262 of each rotation axis. Optical scan angles of 22° and 12° on the inner and outer axes are achieved for frequency values around 2.81 kHz and 670 Hz on the inner and outer rotation axes, respectively. On the other hand, for a static voltage applied between ground and one of combdrive actuators 260, 262 on each rotation axis, off-resonance actuation using only one combdrive actuator results in single-sided deflection. The total optical deflection angle can be doubled by making use of both combdrive actuators 260, 262 on either side of the torsion bars forming the rotation axis. In this respect, off-resonance operation differs significantly from driving at resonant frequency. Optical scan angles of about 5° and 4.5° can be achieved by applying static voltages up to 240 V on the inner and outer axes, respectively.

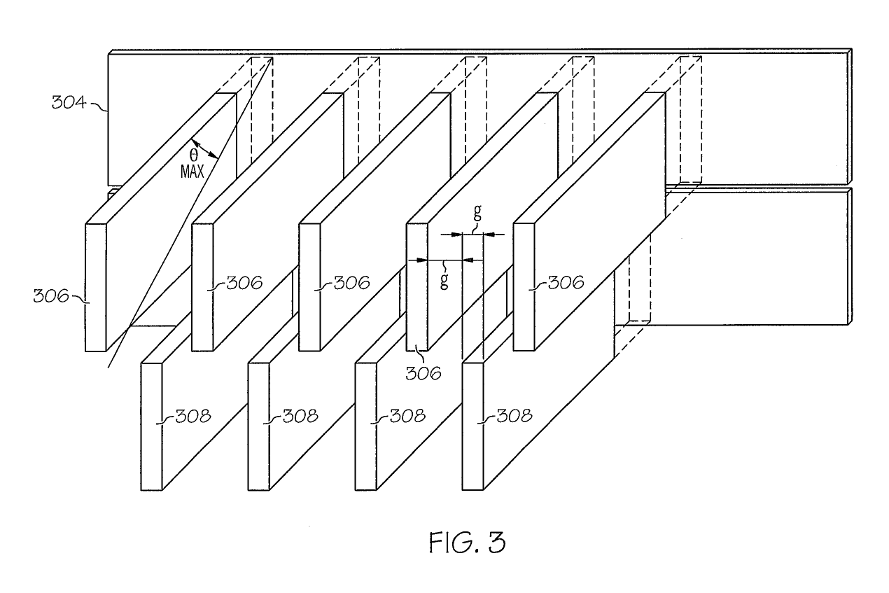

Referring now to FIG. 3, there is illustrated a detailed diagram of combdrive actuators 260 from FIG. 2, in accordance with a preferred embodiment of the present invention. As shown, combdrive actuators 260 include rotor comb fingers 306 and stator comb fingers 308. Preferably, each of stator comb fingers 308 has a width between about 0.5 μm and 50 μm, each of rotor comb fingers 306 has a width between about 0.5 μm and 50 μm, and a target gap spacing g ranges between 0.5 μm and 50 μm. As their names imply, rotor comb fingers 306 are capable of being rotated, while stator comb fingers 308 remain stationary throughout.

In response to a voltage being applied at stator comb fingers 308, rotor comb fingers 306 rotate about a torsion bar 304. Specifically, when a voltage is applied at stator comb fingers 308, an electrostatic torque is experienced by rotor comb fingers 306, which subsequently rotates rotor comb fingers 306 because they are constrained primarily to rotary motion by torsion bar 304. Rotor comb fingers 306 are capable of being rotated to a maximum rotation angle of θₘₐₓ. As rotor comb fingers 306 are being rotated, a shear stress is developed within torsion bar 304 due to twisting, and the shear stress offers a mechanical restoring torque against such twisting. The rotation of rotor comb fingers 306 reaches an equilibrium at a rotation angle at which the electrostatic torque exactly matches the mechanical restoring torque.

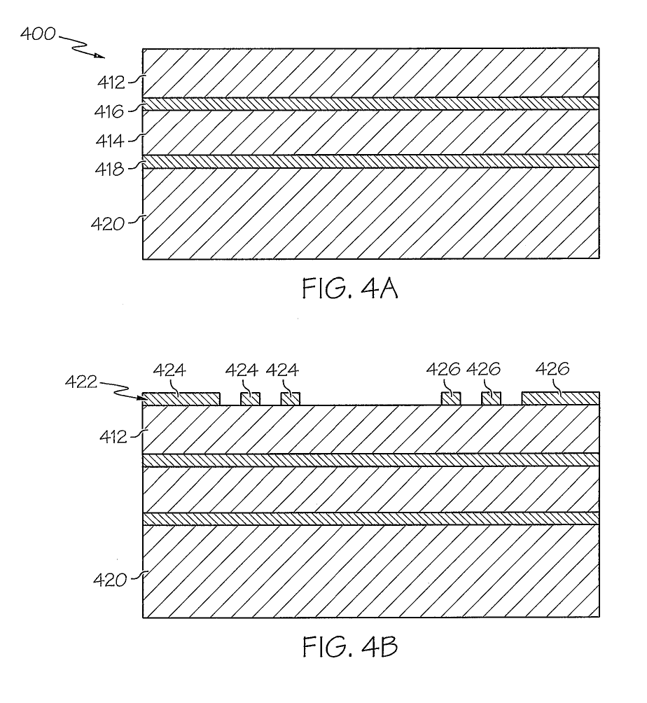

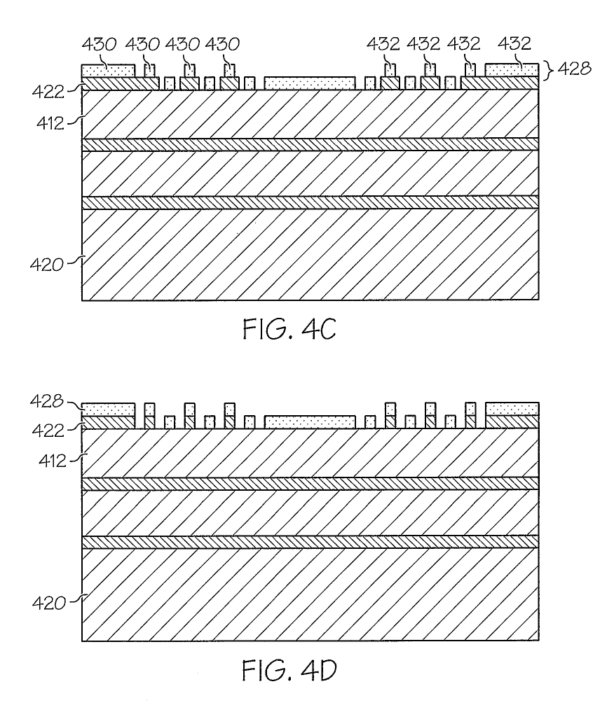

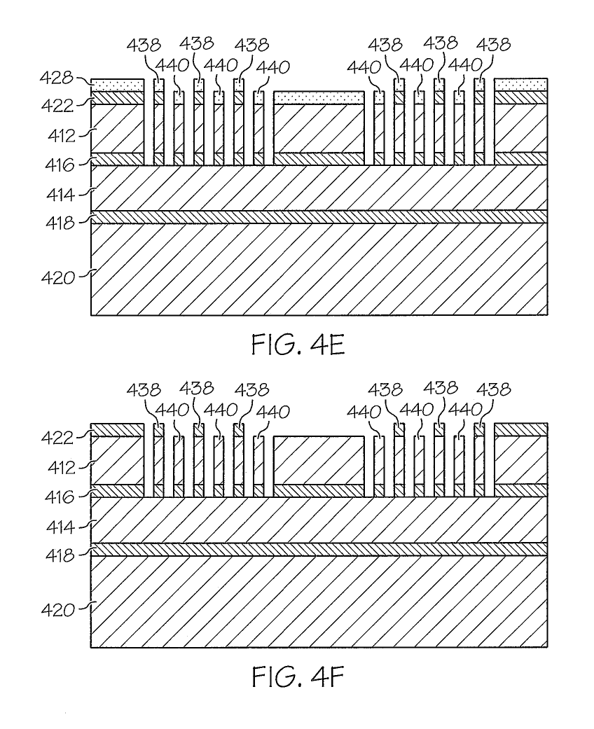

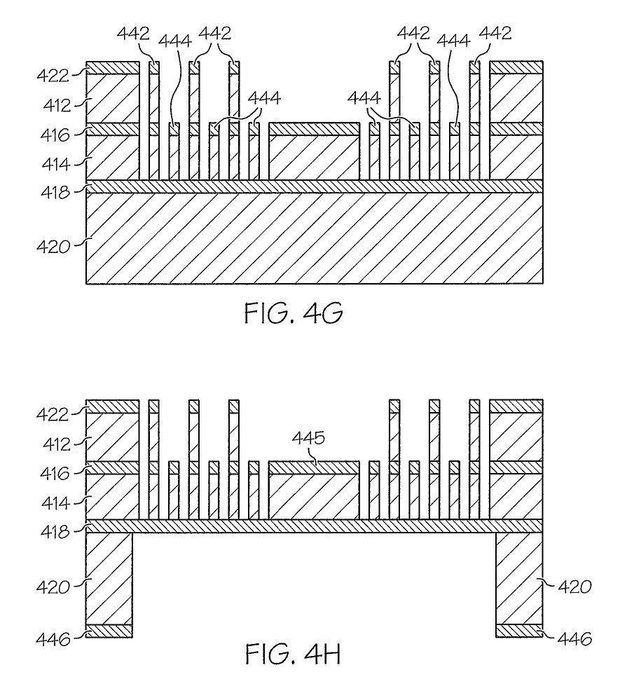

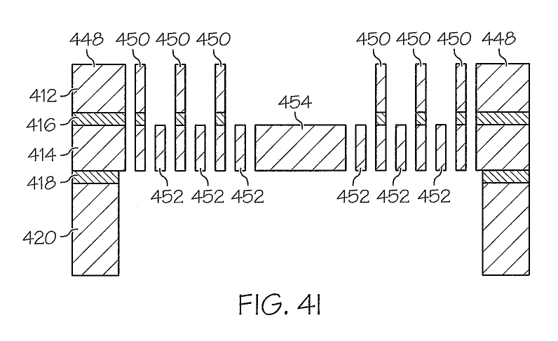

With reference now to FIGS. 4a-4i, there are illustrated a method for fabricating a micromirror, such as micromirror 174 from FIG. 2, in accordance with a preferred embodiment of the present invention. The process begins with a <100> double silicon-on-insulator (SOI) wafer 400. Wafer 400 includes a substrate 420 having two <100> silicon device layers 412, 414 separated from each other by two silicon dioxide layers 416, 418, as shown in FIG. 4a. Each of silicon device layers 412, 414 is approximately 30 μm thick, and each of silicon dioxide layers 416, 418 is approximately 1 μm thick.

Before further processing of wafer 400, pre-fabrication of any complementary-metal-oxide semiconductor (CMOS) circuitry can be performed at this point, if necessary. For example, CMOS circuitry may include control electronics and sensors to adaptively correct for aberrations in a micromirror.

Following the CMOS circuitry pre-fabrication (if performed), wafer 400 is cleaned by immersing wafer 400 in a 9:1 solution of H₂SO₄:H₂O₂ for approximately 8 minutes. After rinsing with de-ionized water, wafer 400 is spun dry. The above-mentioned cleaning process is commonly known as Piranha clean.

Next, wafer 400 is placed into a furnace in which a low-temperature oxide (LTO) layer 422 is deposited on top of silicon device layer 412 via a low-pressure chemical vapor deposition (LPCVD) process at a low temperature (450° C.) in order to reduce thermal budget. LTO layer 422 is preferably a silicon dioxide layer having a thickness between about 50 nm and about 1.5 μm. LTO layer 422 serves to protect any CMOS circuitry and to act as a hard mask for the deep trench etching to be performed to create vertical comb finger structures.

A first photolithography step is performed on LTO layer 422 to etch a set of coarse features 424, 426 of vertical comb finger structures on top of silicon device layer 412. The photolithography step involves coating a layer of hexamethyldisilazane (HMDS) on LTO layer 422, which serves as an adhesion promoter between LTO layer 422 and a photosensitive material to be added. Coarse features 424, 426 are etched in LTO layer 422 via a reactive ion etching (RIE) step using CHF₃ and O₂ gases, as shown in FIG. 4b.

A photosensitive material layer 428, such as Shipley SPR 220-3 positive photoresist, is then spun on LTO layer 422. A second photolithographic step is then performed on photosensitive material layer 428 to etch a set of fine features 430, 432 of vertical comb finger structures on top of LTO layer 422. Fine features 430, 432 are constrained laterally within respective coarse features 424, 426, as shown in FIG. 4c.

The misalignment tolerance for the second photolithography step, which includes a self-alignment step, is half of the gap spacing between stator comb fingers and rotor comb fingers. A significant advantage of the second photolithography step is that if the alignment is deemed to be unsatisfactory on inspection after the second photolithography step, the photoresist can be removed by a Piranha clean, and the self-alignment step can be repeated as many times as necessary. This flexibility eliminates the uncertainty in determining whether or not self-alignment has been achieved, as may happen when the self-alignment is performed to a layer buried deep within a material stack. The minimum comb gap spacing achievable can be determined by the maximum aspect ratio that a silicon deep reactive ion etching (DRIE) tool used in subsequent steps can achieve.

Next, a second RIE step is utilized to remove exposed LTO layer 422 in order to trim coarse features 424, 426 within LTO layer 422 to match the widths of corresponding fine features 430, 432 within photosensitive material layer 428, in order to complete the self-alignment process, as illustrated in FIG. 4d.

Using coarse features 424, 426 within LTO layer 422 and fine features 430, 432 within photosensitive material layer 428 as masks, a DRIE is utilized to remove a portion of silicon device layer 412 (stopped on silicon dioxide layer 416) to form stator comb features 438 and rotor comb features 440 on top of silicon dioxide layer 416, as shown in FIG. 4e. The DRIE is preferably performed in an inductively-coupled plasma generator using SF₆/O₂ and C₄F₈ gases in a pulsed scheme (commonly known as a Bosch process).

A third RIE step is then utilized to remove silicon dioxide layer 416, using coarse features 424, 426 within LTO layer 422 and fine features 430, 432 within photosensitive material layer 428 as masks. Photosensitive material layer 428 is subsequently removed, leaving rotor comb features 440 unprotected by any masking element, while stator comb features 438 are still protected by LTO layer 422, as illustrated in FIG. 4f.

A second DRIE step is utilized to remove portions of silicon device layers 412 and 414 (stopped on silicon dioxide layer 418) to define rotor comb fingers 444 in silicon device layer 414. After the completion of the second DRIE step, rotor comb features 444 reside only in silicon device layer 414, while stator comb features 442 reside in both silicon device layers 412 and 414, as illustrated in FIG. 4g.

The lower section of stator comb features 442 (portions located in silicon device layer 414) is redundant from an actuation perspective, but they do not affect the operation of a micromirror.

A third photolithographic step using a photoresist layer 446 is then performed on a backside of wafer 400 using a third photomask to align to the features on the front side of wafer 400. Preferably, photoresist layer 446 is approximately 15 μm thick and is capable of protecting the underlying silicon through a substrate DRIE step. Photoresist layer 446 can be, for example, Shipley SPR 220-7 positive resist. The third photomask contains the outline of a rotatable mirror structure 445 and is used to remove all silicon directly beneath rotatable mirror structure 445, as illustrated in FIG. 4h.

Since the feature on the third photomask is relatively large (comparable to the size of the entire device), a significant amount of misalignment can be tolerated. Wafer 400 is bound by photoresist to a second silicon substrate (not shown) serving as a mechanical handle in preparation for the backside substrate DRIE step on substrate 420. The backside DRIE step releases the devices and creates dicing lines to facilitate cleaving of wafer 400 into individual chips.

Wafer 400 can be separated from its handle wafer by soaking wafer 400 in acetone, following which a fourth RIE is performed on the front and back sides of wafer 400 to remove any remaining exposed hard mask in LTO layer 422 and silicon dioxide layer 418. The result is an optical scanning device having multiple bond pads 448, stator comb fingers 450, rotor comb fingers 452, and a rotatable mirror 454, as illustrated in FIG. 4i.

As a final step, metals, such as chromium/gold, can be evaporated on the surface of mirror 454 through a shadow mask to improve reflectivity.

As has been described, the present invention provides a method for fabricating micromirrors with self-aligned actuators. The method of the present invention includes the pre-fabrication of CMOS circuitry prior to the micro-electrode-mechanical system (MEMS) process sequence at a low thermal budget. The method of the present invention may utilize conventional silicon processing tools with low-operating temperatures in order to prevent diffusion of previously implanted dopants during the MEMS fabrication steps. The fabrication strategy is a “MEMS-last” strategy, where the micromachining of mechanical structural layers is performed after the completion of the CMOS back-end-of line (BEOL) process steps. This modular strategy offers the advantage of being compatible with any CMOS fabrication process. If the MEMS fabrication sequence is designed to have thermal budget similar to that of a BEOL process, it can be considered as an optional CMOS BEOL process, with no effect on CMOS front-end-of-line (FEOL) processes (especially dopant diffusion steps). If the materials used in the MEMS fabrication sequence are CMOS compatible, the MEMS fabrication can be done as an extension of the CMOS processing. In addition, the difficulties of performing photolithography on previously bulk micromachined substrates present in “MEMS-first” approaches are avoided, which is especially important where high aspect-ratio structures are used in MEMS structures.

While the invention has been particularly shown and described with reference to a preferred embodiment, it will be understood by those skilled in the art that various changes in form and detail may be made therein without departing from the spirit and scope of the invention.

What is claimed is:

1. A method of fabricating a micromirror, said method comprising:
forming a set of coarse features in a low-temperature oxide (LTO) layer deposited on a front side of a wafer having a substrate, a first and second silicon device layers separated from each other by a first and second silicon dioxide layers;
forming a set of fine features in a photosensitive material layer deposited on top of said LTO layer, wherein said fine features are constrained laterally within said coarse features;
removing a portion of said LTO layer to align the width of said coarse features with the width of said fine features;
etching said first silicon dioxide layer and said first and second silicon device layers to form stator comb fingers and rotor comb fingers; and
removing a portion of said substrate on a back side of said wafer, and said silicon dioxide layers from said front and back sides of said wafer to form a rotatable mirror.

2. The method of claim 1, wherein said wafer is a double silicon-on-insulator (SOI) wafer.

3. The method of claim 1, wherein said etching further includes
etching said first silicon device layer by using said LTO layer and said photosensitive material layer as a mask;
etching said first silicon dioxide layer by using said LTO layer and said photosensitive material layer as a mask; and
removing said photosensitive material layer.
